(19) United States
(12) Patent Application Publication
(10) Pub. No.: US 2004/0266973 A1
(43) Pub. Date: Dec. 30, 2004

(54) Alkoxylated alkylphenol-arylaldehyde polymer

(76) Inventors: J. Byron Strickland, Bellaire, TX (US); Paul M. Lindemuth, Sugar Land, TX (US); Grahame N. Taylor, Houston, TX (US)

Correspondence Address: Michael B. Martin, Patent & Licensing Department, Ondeo Nalco Company, Ondeo Nalco Center, Naperville, IL, 60563-1198, US

(21) Appl. No.: 10/602,519

(22) Filed: Jun. 24, 2003

(51) Int. Cl. C08G 8/04; C08G 14/02

(52) U.S. Cl. 528/129

(57) ABSTRACT

An alkoxylated alkylphenol-arylaldehyde polymer prepared by alkoxylating an alkylphenol-arylaldehyde polymer and use of the alkyoxylated alkylphenol-arylaldehyde polymer to resolve water-in-oil emulsions, especially emulsions of water in crude oil.

### TECHNICAL FIELD

This invention relates to compositions and methods of resolving water-in-oil emulsions. More particularly, this invention concerns an alkoxylated alkylphenol-arylaldehyde polymer and use of the polymer to resolve water-in-oil emulsions, particularly emulsions of water in crude oil.

### BACKGROUND OF THE INVENTION

Crude oil produced from geological formations can contain various amounts of water. Water and crude oil are naturally non-miscible. However, when naturally occurring interfacial active compounds are present, these compounds can aggregate on the oil and water interface and cause water to form droplets within the bulk oil phase. During crude oil lifting through production tubings, the oil and water encounters an increased mixing energy from rapid flow through chokes and bends. This additional mixing energy can emulsify the oil and water. This oil external, water internal two-phase system is commonly referred to as a crude oil emulsion. This emulsion can be quite stable. However, the presence of water in crude oil can interfere with refining operations by inducing corrosion, increasing heat capacity and reducing the handling capacity of pipelines and refining equipment. Therefore, the crude oil that is to be shipped out of the oilfield should be practically free of water and usually has a maximum water content limit of about three percent, depending on the type of crude and oil company.

The crude oil associated emulsified water can also contain varying amounts of salts. These salts are detrimental to crude oil refining processes due to potential corrosion and foulant deposition in the refinery. In crude oil refining, desalting techniques comprise the deliberate mixing of the incoming crude oil with a fresh “wash water” to extract the water soluble salts and hydrophilic solids therefrom. The mixing action of heat exchangers and mix valves can produce an emulsion. However, the crude oil routed to refinery distillation equipment is usually required to have less than 0.5 percent water.

Primary dehydration of the crude oil occurs in oil field water oil separation systems such as “free water knock out” and “phase separators”. Refineries employ electrostatic desalters to separate crude oil from the wash water. Quite often these systems are not adequate for efficient separation due to factors such as over capacity, unexpected production changes and system underdesigns. In these cases, emulsion breaking chemicals are added to the production or refining processes to assist and promote rapid separation of water from oil.

Commonly used emulsion breaking chemicals include alkylphenol formaldehyde resin alkoxylates (AFRA), polyalkylene glycol (PAG), organic sulfonates, and the like. These compounds, however, may not provide satisfactory performance in all instances. Accordingly, there is an ongoing need for new, economical and effective chemicals and processes for resolving emulsions into their component parts of oil and water or brine.

### SUMMARY OF THE INVENTION

This invention is an alkoxylated alkylphenol-arylaldehyde polymer comprising repeating units of formula

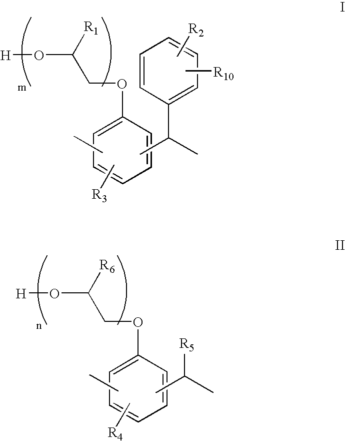

wherein R₁ and R₆ are independently H, methyl or ethyl; R₂ and R₁₀ are independently H, C₁-C₁₈ alkyl, C₅-C₁₀ aryl, hydroxy, alkoxy or halogen; R₃ and R₄ are independently C₁-C₁₈ alkyl; R₅ is H, C₁-C₃ alkyl, arylalkyl or a mixture thereof; and m and n are independently 1 to about 30, wherein the alkoxylated alkylphenol-arylaldehyde polymer comprises 1 to about 40 monomer units of formula I, 0 to about 39 monomer units of formula II and the monomer units of formula I and II are present in a ratio about 1:10 to about 10:1.

### DETAILED DESCRIPTION OF THE INVENTION

The structures of the alkoxylated alkylphenol-arylaldehyde polymers shown herein are representations of the repeating structural units contained in the polymer. No connectivity between the repeating units is shown as it is understood that the units can be randomly mixed in the polymer.

The alkoxylated alkylphenol-arylaldehyde polymer of this invention may be prepared by

i) reacting one or more alkylphenols of formula IV

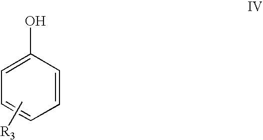

wherein R₃ is straight or branched C₁-C₁₈ alkyl, with about 0.05 to about 1.2 molar equivalents of a arylaldehyde compound of formula V

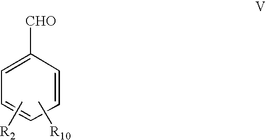

wherein R₂ and R₁₀ are independently H, straight or branched C₁-C₁₈ alkyl, C₅-C₁₀ aryl, hydroxy, alkoxy or halogen and optionally about 0.05 to about 0.95 molar equivalents of one or more aliphatic aldehydes of formula R₅CHO wherein R₅ is H, C₁-C₃ alkyl, or arylalkyl to form an alkylphenol-arylaldehyde polymer; and

ii) reacting the alkylphenol-arylaldehyde polymer with about 1 to about 30 molar equivalents of one or more alkylene oxides.

As used herein, “aliphatic aldehyde” means a compound of formula R₅CHO where R₅ is H, C₁-C₃ alkyl, or arylalkyl. Representative aliphatic aldehydes include formaldehyde, acetaldehyde, propionaldehyde, butyraldehyde, phenylacetaldehyde and the like. Formaldehyde and acetaldehyde are preferred.

“Alkoxy” means a C₁-C₄ alkyl group attached to the parent molecular moiety through an oxygen atom. Representative alkoxy groups include methoxy, ethoxy, propoxy, butoxy, and the like. Methoxy and ethoxy are preferred.

“Alkyl” means a monovalent group derived from a straight or branched chain saturated hydrocarbon by the removal of a single hydrogen atom. Representative alkyl groups include methyl, ethyl, n- and iso-propyl, n-, sec-, iso- and tert-butyl, nonyl, decyl, octadecyl, and the like.

“Alkylene” means a divalent group derived from a straight or branched chain saturated hydrocarbon by the removal of two hydrogen atoms, for example methylene, 1,2-ethylene, 1,1-ethylene, 1,3-propylene, 2,2-dimethylpropylene, and the like.

“Alkylene oxide” means an aliphatic C₂ to C₄ epoxide, for example ethylene oxide, propylene oxide or butylene oxide.

“Alkylphenol-arylaldehyde polymer” includes both alkylphenol-arylaldehyde polymers and alkylphenol-arylaldehyde-aliphatic aldehyde polymers as described herein.

“Aryl” means substituted and unsubstituted aromatic carbocyclic radicals and substituted and unsubstituted heterocyclic radicals having about 5 to about 14 ring atoms. Representative aryl include phenyl, naphthyl, phenanthryl, anthracyl, pyridyl, furyl, pyrrolyl, quinolyl, thienyl, thiazolyl, pyrimidyl, indolyl, and the like. The aryl is optionally substituted with one or more groups selected from hydroxy, halogen, C₁-C₄ alkyl, C₁-C₄ alkoxy and sulfonate.

“Arylalkyl” means an aryl group attached to the parent molecular moiety through an alkylene group. The number of carbon atoms in the alkylene group is selected such that there is a total of about 12 to about 30 carbon atoms in the arylalkyl group. Representative arylalkyl include phenylmethyl (benzyl), phenylethyl, phenylpropyl, 1-naphthylmethyl, and the like. Benzyl is preferred.

“Halogen” means Br, Cl, F or I.

The alkylphenol-arylaldehyde polymer is preferably prepared by dissolving the alkyphenol(s) in a hydrocarbon solvent and warming the mixture to about 60° C. to about 95° C., preferably about 80° C. Suitable solvents include aliphatic solvents such as kerosene and diesel and aromatic solvents such as xylene, toluene and light or heavy aromatic naphtha. The arylaldehyde compound and an appropriate catalyst are then added. Both acid and base catalysts are suitable. Representative acid catalysts include hydrochloric acid, oxalic acid, dodecylbenzenesulfonic acid, toluenesulfonic acid, methylsulfonic acid, and the like. Representative base catalysts include potassium hydroxide and sodium hydroxide. Dodecylbenzenesulfonic acid is preferred.

The reaction mixture is then maintained at reflux for one to five hours and condensate is continuously removed until the desired polymer molecular weight is obtained, typically about one to about three hours. If desired, aliphatic aldehyde and additional solvent may be added to the mixture and heating and condensate removal is continued as above to prepare an alkylphenol-arylaldehyde-aliphatic aldehyde polymer.

In an aspect, the alkylphenol comprises a mixture of a first alkylphenol of formula IV and a dialkylphenol of formula VI

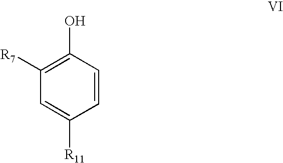

wherein R₇ and R₁₁ are independently C₁-C₁₈ alkyl. The dialkylphenol of formula VI serves to introduce a method of controlling the molecular weight of the resulting alkylphenol-arylaldehyde polymer by providing a chain-terminating group.

The alkoxylated alkylphenol-arylaldehyde polymer is preferably prepared by heating the alkylphenol-arylaldehyde polymer to about 40° C. to about 80° C., preferably about 50° C. About 0.01 to about 0.03 molar equivalents of aqueous base, preferably aqueous potassium hydroxide is then added. The mixture is heated to reflux temperature and reflux is maintained until water removal ceases, typically about 30 minutes. The resulting dehydrated mixture (oxide acceptor) is transferred to an alkoxylation apparatus, a nitrogen atmosphere is established and the acceptor solution is heated to about 140° C. to about 170° C., preferably about 150° C. About 1 to about 30 molar equivalents of alkylene oxide is then added, the reaction temperature is maintained at about 140° C. to about 170° C. and the system pressure is maintained below about 60 psi. The alkylene oxide is allowed to react until the system pressure stabilizes.

In cases where the alkylphenol-arylaldehyde polymer is reacted with more than one alkylene oxide, for example ethylene oxide and propylene oxide, the alkylene oxides may be added in random or block fashion.

Random addition of alkylene oxides involves both components being added to the polymer simultaneously, such that the rate of addition to the polymer is controlled by their relative amounts and reaction rates. An alkoxylated alkylphenol-arylaldehyde polymer prepared by random addition of alkylene oxides or by a mixture of alkylene oxides is referred to herein as a “mixed copolymer”.

In the case of block addition, either of the alkylene oxides is added first to the polymer and allowed to react. The other alkylene oxide is then added and allowed to react. An alkoxylate prepared by block addition of alkylene oxides is referred to herein as a “block copolymer”.

In a preferred aspect of this invention, the alkoxylated alkylphenol-arylaldehyde polymer comprises about 3 to about 40 repeating units of formula I and the repeating unit of formula II is absent.

In another preferred aspect, m and n are independently 1 to about 20.

In another preferred aspect, R₃ and R₄ are independently C₄-C₁₂ alkyl.

In another preferred aspect, R₁ and R₆ are independently H or methyl.

In another preferred aspect, R₅ is H or methyl or a mixture thereof.

In another preferred aspect, R₅ is a mixture of H and methyl in a ratio of about 1:10 to about 10:1.

In another preferred aspect, the alkoxylated alkylphenol-arylaldehyde polymer further comprises a terminal group of formula III

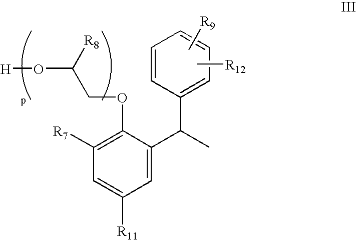

wherein R₇ and R₁₁ are independently C₁-C₁₈ alkyl; R₈ is H, methyl or ethyl; R₉ and R₁₂ are independently H, C₁-C₁₈ alkyl, C₅-C₁₀ aryl, hydroxy, alkoxy or halogen; and p is 1 to about 30.

In another preferred aspect, the alkoxylated alkylphenol-arylaldehyde polymer comprises repeating units of formula VII and VIII

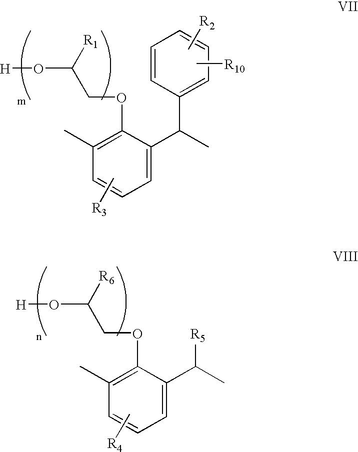

wherein R₁ and R₆ are independently H, methyl or ethyl; R₂ and R₁₀ are independently H, C₁-C₁₈ alkyl, C₅-C₁₀ aryl, hydroxy, alkoxy or halogen; R₃ and R₄ are independently C₁-C₁₈ alkyl; R₅ is H, C₁-C₃ alkyl, or arylalkyl or a mixture thereof; and m and n are independently 1 to about 30, wherein the alkoxylated alkylphenol-arylaldehyde polymer comprises 1 to about 40 monomer units of formula VII, 0 to about 39 monomer units of formula VIII and the monomer units of formula VII and VIII are present in a ratio about 1:10 to about 10:1.

In another preferred aspect, the alkoxylated alkylphenol-arylaldehyde comprises about 3 to about 40 repeating units of formula VII wherein the monomer unit of formula VIII is absent.

In another preferred aspect, the alkoxylated alkylphenol-arylaldehyde polymer comprises about 3 to about 30 repeating units of formula VII wherein m is 1 to about 20; R₁ is H or methyl; R₂ and R₁₀ are H; and R₃ is C₄-C₁₂ alkyl and the repeating unit of formula VIII is absent.

The alkoxylated alkylphenol-arylaldehyde polymer of this invention is effective for resolving a broad range of hydrocarbon emulsions encountered in crude oil production, refining and chemical processing. Specific examples include, but are not limited to, oilfield production emulsions, refinery desalting emulsions, refined fuel emulsions, and recovered oil emulsions (for example crude oil slop, used lubricant oils, and recovered oils in the steel and aluminum industries). The alkoxylated alkylphenol-arylaldehyde polymer is also useful for resolving emulsions in butadiene, styrene, acrylic acid, and other hydrocarbon monomer process streams.

In a preferred aspect of this invention, the alkoxylated alkylphenol-arylaldehyde polymer is used to demulsify water-in-oil emulsions in various crude oil production and refinery processes. In a refinery desalting process, the incoming crude is deliberately mixed with wash water to remove dissolved salts and other contaminants. To extract water from the resulting water-in-crude oil emulsion, the emulsion is admixed with an effective amount of the alkoxylated alkylphenol-arylaldehyde demulsifier of this invention.

In the process of resolving crude petroleum oil emulsions of the water-in-oil type, the alkoxylated alkylphenol-arylaldehyde polymer of the invention is brought into contact with or caused to act upon the emulsion to be treated in any of the various methods now generally used in the petroleum industry to resolve or break crude petroleum oil emulsions with a chemical agent.

For emulsion breaker applications, the polymers can be administered in several ways. They can be used alone or blended with other emulsion breaker components. If used alone, the polymers would typically be dissolved in a suitable solvent to give a solution that comprises about 20 to about 60 percent non-volatile residue (i.e. 80-40% solvent). Most of the alkoxylated alkylphenol-arylaldehyde polymers are hydrocarbon soluble. Typical solvents include toluene, xylene, light or heavy aromatic naphtha, kerosene and the like. Preferred is aromatic naphtha. If the polymers are formulated to be water soluble, the preferred solvent is water. Each component contributes to different treating characteristics when added to the crude oil emulsion due to their unique chemical properties.

In certain instances, co-solvents are required to maintain stability. Co-solvents are typically alcohols (C₃ to C₆), glycol ethers or polar aprotic solvents that are capable of dissolving both polar and non-polar materials. Typical co-solvents include isopropanol, 2-methyl-hexanol, 2-butoxyethanol, dimethylformamide and the like.

The alkoxylated alkylphenol-arylaldehyde polymer may be used alone or in blends with other emulsion breaker materials including alkoxylated alkylphenol-formaldehyde polymers, complex esters, alkoxylated phenols, alkoxylated alcohols, polyethylene or polypropylene glycols and derivatives, arylsulfonates, and the like.

The alkoxylated alkylphenol-arylaldehyde polymer may also be used in combination with corrosion inhibitors, viscosity reducers and other chemical treatments used in crude oil production, refining and chemical processing.

With respect to resolving emulsions encountered in crude oil production, the alkoxylated alkylphenol-arylaldehyde polymer demulsifier is introduced into the crude oil emulsion by injecting beneath the surface into the oil well itself, by injecting into the crude oil at the well-head or by injecting into the crude oil process stream at a point between the well-head and the final oil storage tank. The demulsifier composition may be injected continuously or in batch fashion. The injecting is preferably accomplished using electric or gas pumps.

The treated crude oil emulsion is then allowed to stand in a quiescent state until the desired separation into distinct layers of water and oil results. Once separation into distinct layers of water and oil has been effected, various means known in the art can be utilized for withdrawing the free water and separating crude oil.

In a typical process for demulsification of crude oil, a reservoir is provided to hold the alkoxylated alkylphenol-arylaldehyde polymer in either diluted or undiluted form adjacent to the point where the effluent crude petroleum oil leaves the well. For convenience, the reservoir is connected to a proportioning pump capable of dropwise injecting the demulsifier into the fluids leaving the well, which then pass through a flow line into a settling tank. Generally, the well fluids pass into the settling tank at the bottom of the tank so that incoming fluids do not disturb stratification of the layers of crude petroleum oil and water which takes place during the course of demulsification.

In another preferred aspect of this invention, the water-in-oil emulsion is a refinery desalting emulsion.

The desalting process typically involves the use of pumps to move the incoming crude oil from storage tanks via piping through one or more heat exchangers. Wash water is injected into the heated oil stream and the stream is intimately mixed by an in-line mixing device. The emulsified stream flows into an electrostatic desalter vessel. There, resolution and separation of the crude oil and water effluent occur.

Injection of the demulsifier into the fluid stream can be carried out at various places along the path of the desalting process. Potential injection locations include prior to the crude oil storage tanks, on the outlet side of the crude oil storage tanks, upstream of the in-line mixer, into the wash water stream, and other potential locations.

The amount of alkoxylated alkylphenol-arylaldehyde polymer demulsifier used depends on the particular crude oil emulsion being treated. Bottle tests as described herein may be conducted in order to determine the optimum dose and formulation.

With regard to specific emulsions, the following doses are typical, but may vary outside of the following ranges due to the specific characteristics of the emulsion:

Oilfield production: about 50 to about 500 ppm;

Desalting: about 1 to about 100 ppm;

Refined fuels: about 1 to about 30 ppm;

Recovered oils: about 30 to about 3000 ppm.

The foregoing may be better understood by reference to the following examples, which are presented for purposes of illustration and are not intended to limit the scope of this invention.

### EXAMPLE 1

Preparation of a Nonylphenol-Benzaldehyde Polymer.

Nonylphenol (1.25 mol) and dioctyl sodium sulfosuccinate (7.4 mmol) are dissolved in aromatic naphtha solvent (83 mL). The mixture is heated to 80° C. Benzaldehyde (1.19 mol) and dodecylbenzene sulfonic acid (6.4 mmol) are added and the reaction mixture is warmed to 97-99° C. and maintained at this temperature for three hours. The apparatus is arranged for overhead condensate removal and the reaction mixture is heated to 190-195° C. and maintained for four hours. During this time, generation of condensate water ceases. The mixture is then allowed to cool to 95° C. Additional aromatic solvent (83 mL) is added and the mixture is stirred until homogeneous.

### EXAMPLE 2

Preparation of a Butylphenol-Benzaldehyde Polymer.

Butylphenol (1.47 mol) and dioctyl sodium sulfosuccinate (3.5 mmol) are dissolved in aromatic naphtha (100 mL). The mixture is heated to 80° C. Benzaldehyde (1.47 mol) and dodecylbenzene sulfonic acid (7.5 mmol) are added. The apparatus is arranged for overhead condensate removal and is held at 140° C. for one hour. The temperature is increased to 195-200° C. and maintained for four hours. The mixture is then allowed to cool to 140° C. Additional aromatic solvent (220 mL) is added and the mixture is stirred until homogeneous.

### EXAMPLE 3

Preparation of a Nonylphenol-Formaldehyde-Benzaldehyde Polymer.

Nonyl phenol (1.14 mol) and dodecylbenzenesulfonic acid (2.1 mmol) are dissolved in xylene (135 g). The mixture is heated to 80° C. and aqueous formaldehyde (0.86 mol) is added. The reaction mixture is heated to 100° C. and held there for 60 minutes. Xylene (130 g) is added and the mixture is heated to reflux. Reflux is maintained until water production from the reaction ceases. Benzaldehyde (0.28 mol) is added at reflux. Reflux is maintained until water production from the reaction ceases.

### EXAMPLE 4

Preparation of a Butylphenol-Benzaldehyde-Formaldehyde Polymer.

Butyl phenol (6.66 mol) and dodecylbenzenesulfonic acid (12.6 mmol) are dissolved in xylene (540 g). The mixture is heated to reflux at 167° C. and benzaldehyde (1.67 mol) is added dropwise over 60 minutes. Reflux is maintained until water production ceases. The reaction mixture is cooled to 80° C. Aqueous formaldehyde (5.00 mol) is added over 60 minutes. The mixture is heated to 100° C. and held there for 60 minutes. Xylene (520 g) is added and the mixture is heated to reflux. Heating is continued until water production ceases.

### EXAMPLE 5

Ethoxylation of a Nonylphenol-Benzaldehyde Polymer.

Nonylphenol-benzaldehyde polymer (512 g) is warmed to 50° C. Aqueous potassium hydroxide (3.3 g) is charged and the mixture is stirred for 15 minutes. The mixture is heated to reflux temperature. Reflux is maintained until water removal ceases (approximately 30 minutes). The dehydrated mixture (oxide acceptor) is cooled to approximately 90° C. and is transferred to an ethoxylation apparatus. A nitrogen atmosphere is established in the system and the acceptor solution is heated to 150° C. A calculated quantity of ethylene oxide is added. The reaction temperature is maintained at 150-160° C. and system pressure is maintained below 60 psi. The ethylene oxide is allowed to react until the system pressure stabilizes. A weighed sample is collected. Ethylene oxide addition, reaction, and sample collection is continued as needed to generate a series of six ethoxylated polymer samples (37 to 52% w/w EO).

The alkoxylated alkylphenol-arylaldehyde polymers listed in Table 1 are prepared according to the methods of Examples 1-5.

TABLE 1
Representative Alkoxylated Alkylphenol-Arylaldehyde Polymers

| Polymer | Description |
|---|---|
| 1 | Nonylphenol-benzaldehyde polymer alkoxylate (29% ethylene oxide) |
| 2 | Nonylphenol-benzaldehyde polymer alkoxylate (33% ethylene oxide) |
| 3 | Nonylphenol-benzaldehyde polymer alkoxylate (38% ethylene oxide) |
| 4 | Nonylphenol-benzaldehyde polymer alkoxylate (41% ethylene oxide) |
| 5 | Nonylphenol-benzaldehyde polymer alkoxylate (44% ethylene oxide) |
| 6 | Nonylphenol-benzaldehyde polymer alkoxylate (47% ethylene oxide) |
| 7 | Nonylphenol-dinonylphenol-benzaldehyde polymer alkoxylate (37% ethylene oxide) |
| 8 | Nonylphenol-dinonylphenol-benzaldehyde polymer alkoxylate (41% ethylene oxide) |
| 9 | Nonylphenol-dinonylphenol-benzaldehyde polymer alkoxylate (44% ethylene oxide) |
| 10 | Nonylphenol-dinonylphenol-benzaldehyde polymer alkoxylate (47% ethylene oxide) |
| 11 | Nonylphenol-dinonylphenol-benzaldehyde polymer alkoxylate (50% ethylene oxide) |
| 12 | Nonylphenol-dinonylphenol-benzaldehyde polymer alkoxylate (52% ethylene oxide) |
| 13 | Nonylphenol-benzaldehyde polymer alkoxylate (38% ethylene oxide) |
| 14 | Nonylphenol-benzaldehyde polymer alkoxylate (41% ethylene oxide) |
| 15 | Nonylphenol-benzaldehyde polymer alkoxylate (45% ethylene oxide) |
| 16 | Nonylphenol-benzaldehyde polymer alkoxylate (48% ethylene oxide) |
| 17 | Nonylphenol-benzaldehyde polymer alkoxylate (50% ethylene oxide) |
| 18 | Nonylphenol-benzaldehyde polymer alkoxylate (53% ethylene oxide) |
| 19 | Commercial Sample |
| 20 | Mixture of nonylphenol-formaldehyde polymer alkoxylate (44% ethylene oxide) and |
| | alkoxylated propylene glycol-acrylate esters and nonylphenol-formaldehyde polymer |
| | alkoxylate (53% ethylene oxide) |
| 21 | Mixture of nonylphenol-dinonylphenol-formaldehyde polymer alkoxylate (42% |
| | ethylene oxide) and amylphenol-formaldehyde polymer alkoxylate (30% ethylene |
| | oxide) |
| 22 | Mixture of nonylphenol-dinonylphenol-formaldehyde polymer alkoxylate (42% |
| | ethylene oxide) and butylphenol-formaldehyde polymer alkoxylate (32% ethylene |
| | oxide) |
| 23 | Mixture of nonylphenol-formaldehyde polymer alkoxylate (37% ethylene oxide) and |
| | nonylphenol-formaldehyde polymer alkoxylate (53% ethylene oxide) |
| 24 | Nonylphenol-formaldehyde polymer alkoxylate (44% ethylene oxide) |
| 25 | Amylphenol-formaldehyde polymer alkoxylate (30% ethylene oxide) |
| 26 | Nonylphenol-dinonylphenol-formaldehyde polymer alkoxylate (42% ethylene oxide) |
| 27 | Butylphenol-formaldehyde polymer alkoxylate (32% ethylene oxide) |
| 28 | Mixture of alkoxylated propylene glycol-acrylate esters and nonylphenol-formaldehyde |
| | polymer alkoxylate (53% ethylene oxide) |
| 29 | Mixture of nonylphenol-benzaldehyde polymer alkoxylate (44% ethylene oxide) and |
| | alkoxylated propylene glycol-acrylate esters and nonylphenol-formaldehyde polymer |
| | alkoxylate (53% ethylene oxide) |
| 30 | Mixture of nonylphenol-benzaldehyde polymer alkoxylate (47% ethylene oxide) and |
| | alkoxylated propylene glycol-acrylate esters and nonylphenol-formaldehyde polymer |
| | alkoxylate (53% ethylene oxide) |
| 31 | Mixture of nonylphenol-benzaldehyde polymer alkoxylate (47% ethylene oxide) |
| | and nonylphenol-formaldehyde polymer alkoxylate (44% ethylene oxide) |
| 32 | Mixture of nonylphenol-benzaldehyde polymer alkoxylate (47% ethylene oxide) |
| | and amylphenol-formaldehyde polymer alkoxylate (30% ethylene oxide) |
| 33 | Mixture of nonylphenol-benzaldehyde polymer alkoxylate (47% ethylene oxide) and |
| | nonyl-dinonylphenol-formaldehyde polymer alkoxylate (42% ethylene oxide) |
| 34 | Mixture of nonylphenol-benzaldehyde polymer alkoxylate (47% ethylene oxide) and |
| | butylphenol-formaldehyde polymer alkoxylate (32% ethylene oxide) |
| 35 | Nonylphenol-benzaldehyde polymer alkoxylate (40% ethylene oxide) |
| 36 | Nonylphenol-benzaldehyde polymer alkoxylate (40% ethylene oxide) |
| 37 | Nonylphenol-formaldehyde polymer alkoxylate (40% propylene oxide, 30% ethylene |
| | oxide) |
| 38 | Commercial Product |
| 39 | Commercial Product |
| 40 | Commercial Product |
| 41 | Mixture of nonylphenol-benzaldehyde polymer alkoxylate (38% ethylene oxide) and |
| | nonylphenol-formaldehyde polymer alkoxylate (40% propylene oxide, 30% ethylene |
| | oxide) |

### EXAMPLE 6

Testing of Emulsion Breakers for Desalting Applications.

Desalting application tests are performed using a bottle test procedure. Raw desalter crude oil is combined with desalter wash water and emulsion breaker product in a test bottle. Typical product treat-rates are 3-30 ppm by volume. The contents are mixed by hand and are heated to about 180° F. in a water bath. The heated contents are mixed to generate an emulsion. The emulsion is transferred to a graduated container and is heated at about 180° F. for 30 minutes. The partially resolved emulsion is centrifuged for three minutes. The volume of separated water (free water) and unresolved emulsion (emulsion) are measured and recorded. The results are summarized in Table 2.

In Table 2, free water and emulsion values are measured in mL. Interface values are rated on a scale of 1 to 4. A value of 1 indicates a poor interface and a value of 4 indicates an excellent interface.

TABLE 2
Desalting Application Test Results

| | | Free | | |
|---|---|---|---|---|
| Test | Polymer | Water | Emulsion | Interface |
| A | 1 | 0.3 | 4.1 | 1 |
| | 2 | 0.9 | 3.6 | 2 |
| | 3 | 1.2 | 3.3 | 1 |
| | 4 | 1.1 | 3.1 | 1 |
| | 5 | 2.4 | 1.9 | 1 |
| | 6 | 3.5 | 0.4 | 4 |
| | 20 | 3.4 | 0.6 | 4 |
| | 26 | 2.3 | 1.9 | 2 |
| B | 6 | 3.4 | 0.7 | 2 |
| | 7 | 1.6 | 2.1 | 1 |
| | 8 | 2.6 | 1.8 | 2 |
| | 9 | 2.4 | 1.6 | 1 |
| | 10 | 3.2 | 0.8 | 2 |
| | 11 | 2.8 | 1.3 | 1 |
| | 12 | 2.8 | 1.5 | 1 |
| | 26 | 2.5 | 1.5 | 2 |
| C | 6 | 3.9 | 0.1 | 4 |
| | 13 | 1.7 | 2.3 | 1 |
| | 14 | 2.0 | 2.1 | 1 |
| | 15 | 3.0 | 1.0 | 3 |
| | 16 | 3.6 | 0.4 | 4 |
| | 17 | 2.9 | 1.1 | 3 |
| | 18 | 2.4 | 1.6 | 4 |
| | 26 | 1.5 | 2.2 | 1 |
| D | 20 | 3.7 | 0.3 | 4 |
| | 21 | 2.5 | 1.9 | 3 |
| | 22 | 1.3 | 3.2 | 2 |
| | 23 | 0.3 | 4.1 | 1 |
| | 24 | 2.4 | 1.9 | 2 |
| | 26 | 0.6 | 3.8 | 1 |
| | 27 | 2.6 | 1.9 | 3 |
| | 29 | 3.9 | 0.1 | 4 |
| E | 6 | 1.4 | 2.9 | 2 |
| | 19 | 1.5 | 2.8 | 2 |
| | 20 | 2.9 | 1.2 | 3 |
| | 22 | 1.1 | 3.3 | 2 |
| | 24 | 1.5 | 2.5 | 3 |
| | 28 | 1.8 | 2.5 | 1 |
| | 30 | 2.3 | 1.8 | 3 |
| | 31 | 3.4 | 0.6 | 4 |
| F | 20 | 1.2 | 2.6 | 1 |
| | 21 | 2.0 | 2.0 | 3 |
| | 22 | 1.0 | 2.8 | 1 |
| | 30 | 2.5 | 1.3 | 2 |
| | 31 | 1.5 | 2.5 | 2 |
| | 32 | 1.2 | 2.7 | 2 |
| | 33 | 2.4 | 1.4 | 3 |
| | 34 | 0.9 | 3.0 | 2 |

The data shown in Table 2 reveal that alkylphenol-arylaldehyde polymer demulsifiers of this invention show improved performance relative to demulsifiers based on traditional chemistries or currently available commercial products.

### EXAMPLE 7

Testing of Emulsion Breakers for Oilfield Applications.

Oilfield emulsion breaker tests are performed using a typical bottle test procedure that is well known to those skilled in the art. A fresh emulsion sample is collected from a field site. The site selected provides a sample that is free from emulsion breaker additives. Free water is removed and the remaining emulsion is transferred into graduated bottles. Test chemicals are added and contents of the bottle are mixed with hand agitation. Bottles are placed in a bath at field system temperature. Water separation (water drop) is measured and is recorded at timed intervals. This series of measurements indicates the ability of the test chemical to assist in water coalescence from the emulsion.

At the conclusion of the water drop test, a sample from the dry oil layer is withdrawn (thief) using a pipet. The thief sample is transferred to a centrifuge tube, is blended with a hydrocarbon solvent and emulsion breaker chemical, and is centrifuged. The amount of water in the thief sample is determined from the water collected in the bottom of the centrifuge tube. This measurement indicated the ability of the test chemical to provide dry crude oil.

Finally, the dropped free water layer is separated from the original test bottle. The remaining crude oil and emulsion is thoroughly mixed to form a composite. A composite sample is transferred to a centrifuge tube, is blended with a hydrocarbon solvent and emulsion breaker chemical, and is centrifuged. The amount of water and solids in the composite sample is determined from the quantity measured in the bottom of the centrifuge tube. This measurement indicates the ability of the test chemical to break interface emulsion.

The Results are summarized in Table 3. Values for water drop, thief slug and composite BS are measured in milliliters.

TABLE 3
Oilfield Application Test Results

| Crude Oil | Demulsifier | Water Drop | Thief Slug | Composite BS |
|---|---|---|---|---|
| A | 35 | 32 | 1.2 | 0.8 |
| | 36 | 32 | 1.9 | 0.5 |
| | 38 | 36 | 1.2 | 0.6 |
| | 39 | 26 | 2.8 | 0.7 |
| | Blank | 22 | 4.8 | 2.5 |
| B | 3 | 50 | 1.6 | 15.2 |
| | 37 | 45 | 1.8 | 1.0 |
| | 38 | 51 | 1.9 | 1.5 |
| | 40 | 50 | 2.0 | 1.2 |
| | 41 | 58 | 0.9 | 0.4 |
| | Blank | 2 | na | na |

As shown in Table 3, in crude oil A, single-component alkylphenol-arylaldehyde polymers 35 and 36 perform similarly to commercial products 38 and 39. In crude oil B, a blend (41) of alkylphenol-arylaldehyde polymer 3 and alkylphenol-arylaldehyde polymer 37 outperforms commercial products 38 and 40 and the individual alkylphenol-arylaldehyde polymers 3 and 37.

Changes can be made in the composition, operation and arrangement of the method of the invention described herein without departing from the concept and scope of the invention as defined in the claims.

1. An alkoxylated alkylphenol-arylaldehyde polymer comprising repeating units of formula 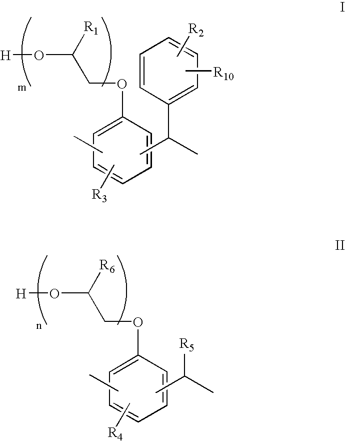
wherein R₁ and R₆ are independently H, methyl or ethyl; R₂ and R₁₀ are independently H, C₁-C₁₈ alkyl, C₅-C₁₀ aryl, hydroxy, alkoxy or halogen; R₃ and R₄ are independently C₁-C₁₈ alkyl; R₅ is H, C₁-C₃ alkyl, or arylalkyl or a mixture thereof; and m and n are independently 1 to about 30, wherein the alkoxylated alkylphenol-arylaldehyde polymer comprises 1 to about 40 monomer units of formula I, 0 to about 39 monomer units of formula II and the monomer units of formula I and II are present in a ratio about 1:10 to about 10:1.

2. The alkoxylated alkylphenol-arylaldehyde polymer of claim 1 wherein R₂ and R₁₀ are H.

3. The alkoxylated alkylphenol-arylaldehyde polymer of claim 1 comprising about 3 to about 40 repeating units of formula I wherein the monomer unit of formula II is absent.

4. The alkoxylated alkylphenol-arylaldehyde polymer of claim 1 wherein m and n are independently 1 to about 20.

5. The alkoxylated alkylphenol-arylaldehyde polymer of claim 1 wherein R₃ and R₄ are independently C₄-C₁₂ alkyl.

6. The alkoxylated alkylphenol-arylaldehyde polymer of claim 1 wherein R₁ and R₆ are independently H or methyl.

7. The alkoxylated alkylphenol-arylaldehyde polymer of claim 1 wherein R₅ is H or methyl or a mixture thereof.

8. The alkoxylated alkylphenol-arylaldehyde polymer of claim 7 wherein R₅ is a mixture of H and methyl in a ratio of about 1:10 to about 10:1.

9. The alkoxylated alkylphenol-arylaldehyde polymer of claim 1 further comprising a terminal group of formula III 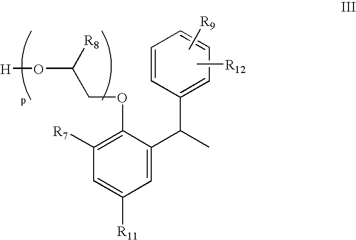
wherein R₇ and R₁₁ are independently C₁-C₁₈ alkyl; R₈ is H, methyl or ethyl; R₉ and R₁₂ are independently H, C₁-C₁₈ alkyl, C₅-C₁₀ aryl, hydroxy, alkoxy or halogen; and p is 1 to about 30.

10. An alkoxylated alkylphenol-arylaldehyde polymer according to claim 1 comprising repeating units of formula VII and VIII 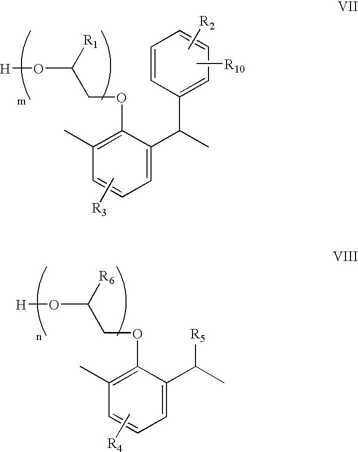
wherein R₁ and R₆ are independently H, methyl or ethyl; R₂ and R₁₀ are independently H, C₁-C₁₈ alkyl, C₅-C₁₀ aryl, hydroxy, alkoxy or halogen; R₃ and R₄ are independently C₁-C₁₈ alkyl; R₅ is H, C₁-C₃ alkyl, or arylalkyl or a mixture thereof; and m and n are independently 1 to about 30, wherein the alkoxylated alkylphenol-arylaldehyde polymer comprises 1 to about 40 monomer units of formula VII, 0 to about 39 monomer units of formula VIII and the monomer units of formula VII and VIII are present in a ratio about 1:10 to about 10:1.

11. The alkoxylated alkylphenol-arylaldehyde polymer of claim 10 comprising about 3 to about 40 repeating units of formula VII wherein the monomer unit of formula VIII is absent.

12. The alkoxylated alkylphenol-arylaldehyde polymer of claim 11 comprising about 3 to about 30 repeating units of formula VII wherein m is 1 to about 20; R₁ is H or methyl; R₂ and R₁₀ are H; and R₃ is C₄-C₁₂ alkyl.

13. A demulsifier composition for resolving water-in-oil emulsions comprising one or more alkoxylated alkylphenol-arylaldehyde polymers according to claim 1.

14. A method of preparing the alkoxylated alkylphenol-arylaldehyde polymer of claim 1 comprising:
i) reacting one or more alkylphenols of formula IV 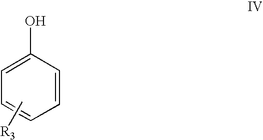
wherein R₃ is H or straight or branched C₁-C₁₈ alkyl, with about 0.05 to about 1.2 molar equivalents of a arylaldehyde compound of formula V 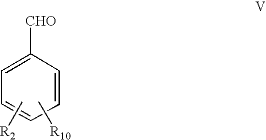
wherein R₂ and R₁₀ are independently H, straight or branched C₁-C₁₈ alkyl, C₅-C₁₀ aryl, hydroxy, alkoxy or halogen and optionally about 0.05 to about 0.95 molar equivalents of one or more aliphatic aldehydes of formula R₅CHO wherein R₅ is H, C₁-C₃ alkyl, or arylalkyl to form an alkylphenol-arylaldehyde polymer; and
ii) reacting the alkylphenol-arylaldehyde polymer with about 1 to about 30 molar equivalents of one or more alkylene oxides.

15. The method of claim 14 wherein the alkylphenol comprises a mixture of the alkylphenol of formula IV and a dialkylphenol of formula VI 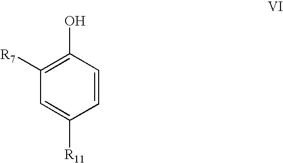
wherein R₇ and R₁₁ are independently C₁-C₁₈ alkyl.

16. A method of resolving a water-in-oil emulsion comprising adding to the emulsion an effective demulsifying amount of one or more alkoxylated alkylphenol-arylaldehyde polymers according to claim 1.

17. The method of claim 16 wherein the water-in-oil emulsion is a crude oil emulsion.

18. The method of claim 17 wherein the crude oil emulsion is a refinery desalting emulsion.

19. The method of claim 17 wherein the crude oil emulsion is a crude oil production emulsion.
